(19) United States
(12) Patent Application Publication
(10) Pub. No.: US 2025/0129948 A1
(43) Pub. Date: Apr. 24, 2025

(54) HEATED FLOORING

(71) Applicant: Carter Associates, Inc., Burr Oak, MI (US)

(72) Inventor: Alan T. CARTER, Sturgis, MI (US)

(21) Appl. No.: 18/918,711

(22) Filed: Oct. 17, 2024

Related U.S. Application Data
(60) Provisional application No. 63/591,532, filed on Oct. 19, 2023.

(51) Int. Cl. F24D 13/02; H05B 3/14; H05B 3/22

(52) U.S. Cl. CPC F24D 13/024; H05B 3/145; H05B 3/22; H05B 2203/026

(57) ABSTRACT

Heated flooring comprising a plurality of spaced joists, a support surface connected to tops of the joists, and a heating assembly connected to the joists for heating a space between the support surface and the heating assembly. The heating assembly includes a support panel, a heated layer and a top layer, the heated layer being located between the support panel and the top layer, with the heating assembly including a heated surface. The support surface has folded sides forming connection portions that are connected to the joists and accurately space the heated surface from a bottom of the support surface.

### CROSS-REFERENCE TO RELATED APPLICATION

This claims the benefit of U.S. Provisional Application No. 63/591,532, filed Oct. 19, 2023, the disclosure of which is hereby incorporated by reference in its entirety.

The present invention relates to flooring, and in particular to heated flooring.

### BACKGROUND OF THE INVENTION

Heated flooring for houses, buildings or portions thereof are desired to help heat a house and make the floor comfortable to walk upon.

### SUMMARY OF THE INVENTION

The present invention, according to one aspect, is directed to heated flooring comprising a plurality of spaced joists, a support surface connected to tops of the joists, and a heating assembly connected to the joists for heating a space between the support surface and the heating assembly. the heating assembly includes a support panel, a heated layer and a top layer, the heated layer being located between the support panel and the top layer, with the heating assembly including a heated surface. The support surface has folded sides forming connection portions that are connected to the joists and accurately space the heated surface from a bottom of the support surface.

Another aspect of the present invention is to provide a heating assembly comprising a support panel, a heated layer comprising graphene, a top layer, and a heated surface. The heated layer is located between the support panel and the top layer to form the heated surface at a top of the heating assembly. The support panel includes a support portion and weakened fold lines along opposite longitudinal sides thereof forming connection portions. The connection portions are configured to be folded along the weakened fold lines and connected to joists of a building, thereby accurately spacing the heated surface from a bottom of the support surface.

### BRIEF DESCRIPTION OF THE DRAWINGS

One or more embodiments of the present invention are illustrated by way of example and should not be construed as being limited to the specific embodiments depicted in the accompanying drawings, in which like reference numerals indicate similar elements.

FIG. 1 is a perspective view of heated flooring of the present invention.

FIG. 2 is a top view of a heating assembly of the heated flooring of the present invention.

FIG. 3 is an enlarged view of the heating assembly of the heated flooring of the present invention taken in circle III of FIG. 2.

FIG. 4 is a perspective view of a support panel of the heating assembly of the heated flooring of the present invention.

FIG. 5 is a top view of the support panel of the present invention.

FIG. 6 is a top view of a heated layer of the heating assembly of the heated flooring of the present invention.

FIG. 7 is a top view of the heating assembly of the heated flooring of the present invention in an installation position.

FIG. 8 is a side view of the heating assembly of the heated flooring of the present invention in an installation position.

The specific devices and processes illustrated in the attached drawings and described in the following specification are simply exemplary embodiments of the inventive concepts. Hence, specific dimensions and other physical characteristics relating to the embodiments disclosed herein are not to be considered as limiting.

### DETAILED DESCRIPTION

For purposes of description herein, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined herein. Hence, specific dimensions and other physical characteristics relating to the embodiments disclosed herein are not to be considered as limiting, unless expressly stated otherwise.

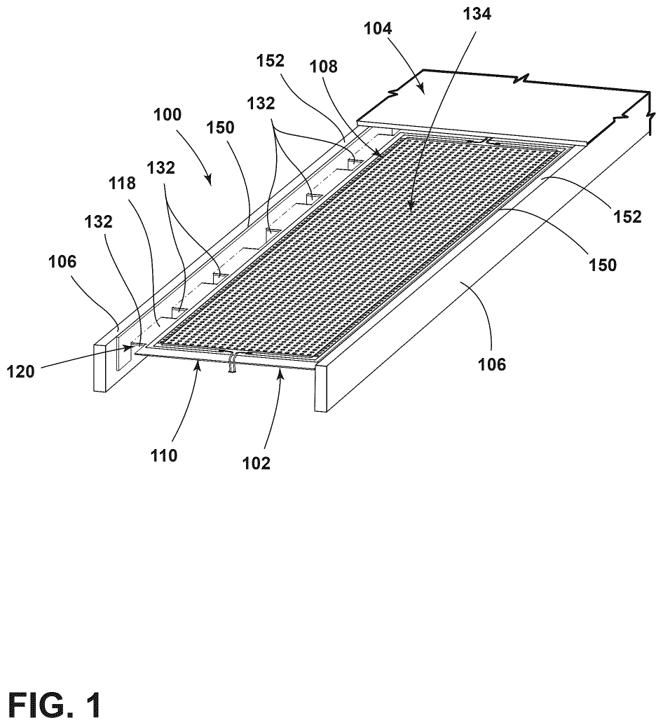

The reference number 100 (FIG. 1) generally designates a heated flooring of the present invention. The heated flooring 100 includes a walking surface 104 supported by a plurality of joists 106. A heating assembly 102 is connected between a pair of adjacent joists 106 for heating a space 108 directly below the walking surface 104. During use, the heating assembly 102 is activated to heat the air in the space 108, which thereby in turn heats the walking surface 104. The walking surface 104 can include any upper surface including tile, carpet, vinyl, laminate or any other surface. Use of the heating assembly 102 allows the walking surface 104 to maintain a comfortable temperature.

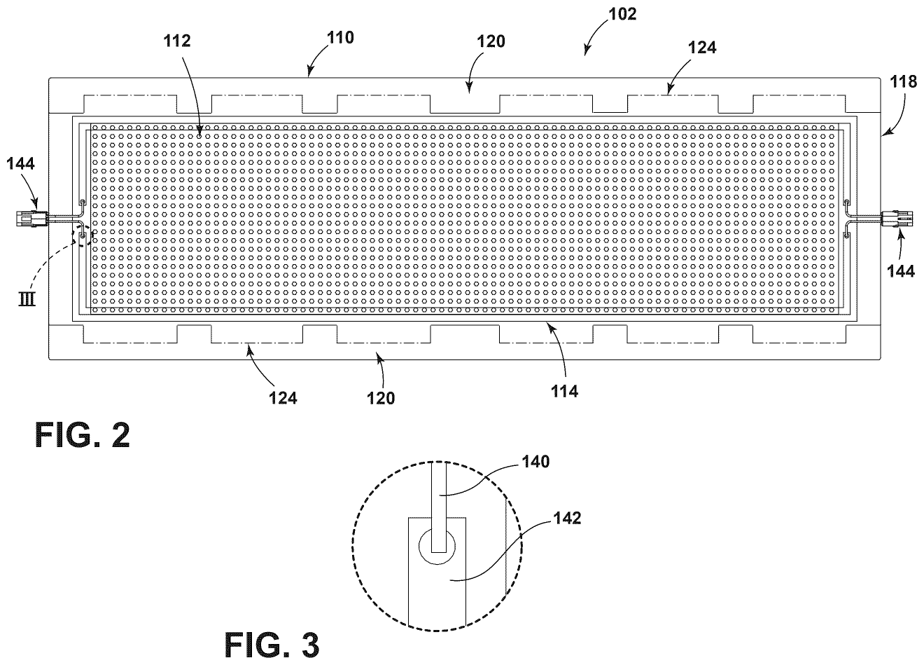

The illustrated heating assembly 102 as shown in FIGS. 1 and 2 is connected to the joists 106 to selectively heat the walking surface 104. The heating assembly 102 includes a support panel 110, a heated layer 112, and a top layer 114. The top layer 114 and the support panel 110 form a laminate including the heated layer 112 laminated between the support panel 110 and the top layer 114.

In the illustrated example, the support panel 110 of the heating assembly 102 supports the remaining elements of the heating assembly 102 and is employed to connect the heating assembly 102 to the joists 106. The support panel 110 can be made from any material that provides support and protection for the remaining layers of the heating assembly 102. In the illustrated example, the support panel 110 can be formed from 9 mm pp 2000 gsm cellular board. Therefore, in the illustrated example, the support panel 110 can be formed from polypropylene into cells having 2000 grams per square meter and being 9 mm thick. The support panel 110 has a substantially rectangular configuration until folded into a configuration ready for installation in a building as described in more detail below.

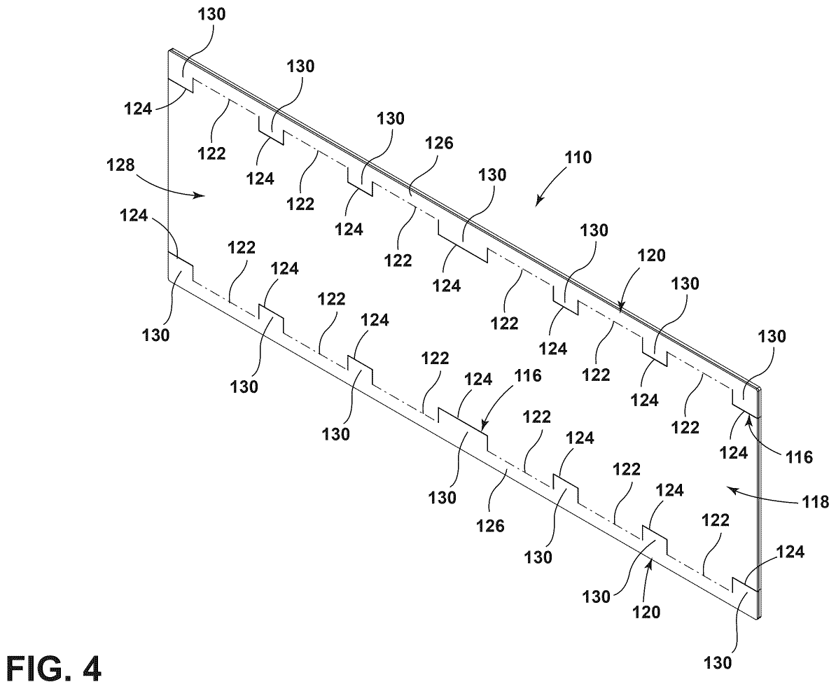

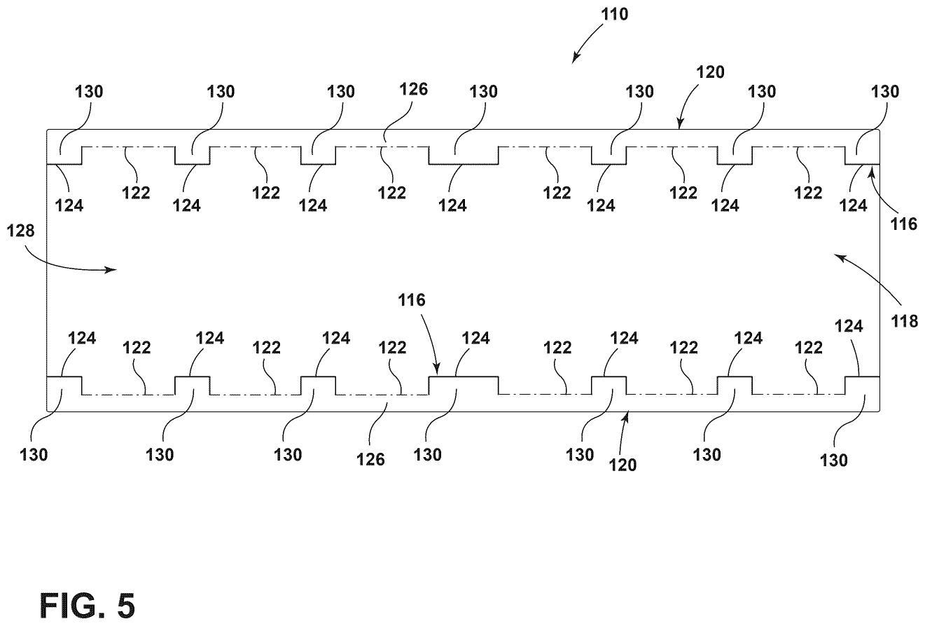

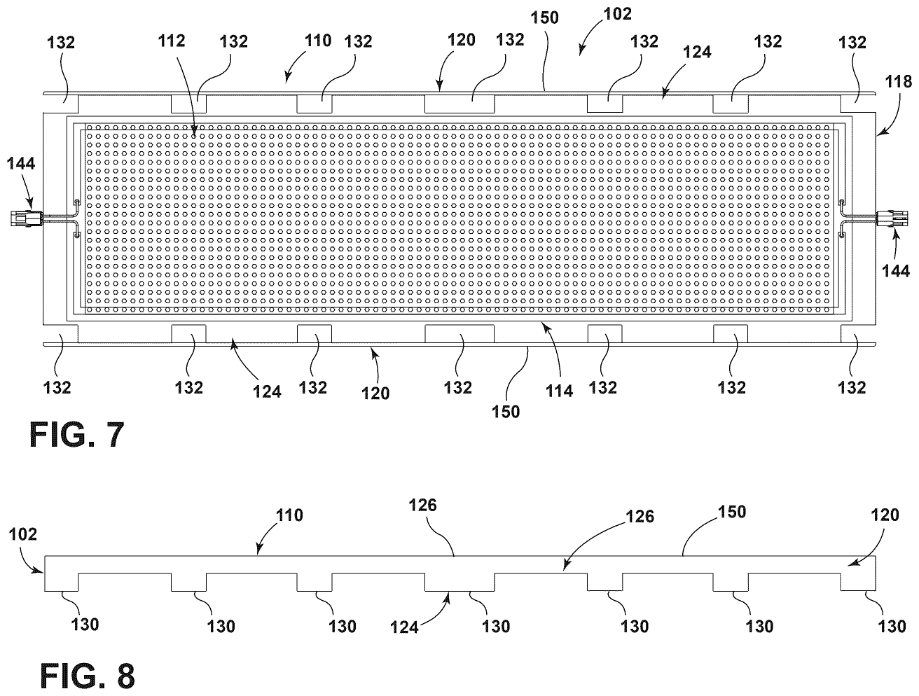

As shown in FIG. 4, the support panel 110 includes a rectangular step wave pattern 116 spaced from each longitudinal edge that defies a transition between a flat support portion 118 and a connection portion 120. The connection portion 120 is folded into a vertical position for installation. The rectangular step wave pattern 116 includes an interrupted weakened line 122 that forms a living hinge as the connection portion 120 is bent relative to the flat support portion 118. The rectangular step wave pattern 116 also includes a plurality of U-shaped cut lines 124 that is cut through the support panel 110. As the heating assembly 102 is configured into the installation position, the connection portion 120 is bent along the interrupted weakened line 122 relative to the flat support portion 118. The connection portion 120, when the heating assembly 102 is configured into the installation position, includes an upper rectangular connection portion 126 that extends upward from an upper surface 128 of the flat support portion 118 and a plurality of lower rectangular connection portions 130 that extend downward from the flat support portion 118. In the installation position, the support panel 110 includes a plurality of rectangular openings 132 located between the flat support portion 118 and the connection portion 120 as shown in FIGS. 1 and 7. The rectangular openings 132 are formed when the connection portion 120 is folded away from the flat support portion 118.

The illustrated heated layer 112 is positioned on the flat support portion 118 of the support panel 110 and heats the heating assembly 102. It is contemplated that a heated surface 134 of the heating assembly 102 could be heated by the heated layer 112 up to a temperature of 110° F. without any localized hot spots (i.e., a uniform temperature across the entire heated surface 134). Moreover, it is contemplated that the heating assembly 102 can be powered by 1 amp.

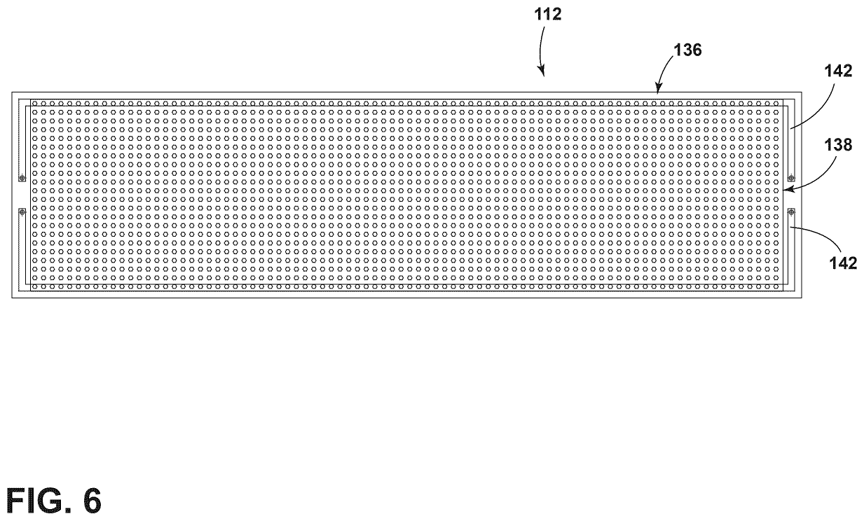

In the illustrated example, the heated layer 112 (FIG. 6) is heated to heat the heating assembly 102. The heated layer 112 comprises a substrate 136 having a heatable material 138 printed thereon. In the illustrated example, the heatable material 138 printed on the substrate 136 is graphene. The graphene of the heatable material 138 is printed across the substrate 136 with a plurality of voids as shown in FIG. 6. As shown in FIG. 6, the substrate 136 includes ribbon leads 142 extending to the heatable material 138. The ribbon leads 142 and the heatable material 138 are configured to form a circuit with wires 140 (see FIGS. 2 and 3) connected to a power supply (not shown). As shown in FIG. 3, the wires 140 can be soldered or otherwise connected or joined to the ribbon leads 142. The wires 140 can have a connector 144 connected thereto as shown in FIG. 2, with the connectors 144 being configured to be connected to a power source or connectors 144 of adjacent heating assemblies 102 (which are in turn ultimately connected to a power source).

When the circuit is formed and power conducted therethrough, the heatable material 138 will raise in temperature, thereby heating the heated layer 112 and the heating assembly 102. An example of the heated layer 112 is sold by Radiant Panel Technologies, LLC of Cheyenne, Wyoming under the name GRAPHENE HEAT FILM.

The illustrated top layer 114 rests on the bottom support panel 110 and the heated layer 112. The top layer 114 can be any layer that transfers heat from the heatable material 138 of the heated layer 112 to the heated surface 134. It is contemplated that the top layer 114 can be elastic. In the illustrated example, the top layer 114 can be a TPO (thermoplastic polyolefin) layer having a spun polyester (fleece) backing that is mechanically attached to the TPO layer during an extrusion manufacturing process.

The illustrated heating assembly 102 can be formed by connecting the wires 140 to the ribbon leads 142 of the heated layer 112 and then sandwiching the heated layer 112 between the support panel 110 and the top layer 114. In the process of making the heated flooring, the periphery of the top layer 114 can be heated and pressurized against the support panel 110 to seal the heated layer 112 therein. The entrance of the wires 140 into the rest of the heating assembly 102 can also be sealed (e.g., in a waterproof manner) to protect the heated layer 112.

The heating assembly 102 is configured to be connected between a pair of the joists 106. In order to prepare the heating assembly 102 for installation, the connection portion 120 is folded about the interrupted weakened line 122 as shown in FIG. 8, with the upper rectangular connection portion 126 extending upward from the upper surface 128 of the support panel 110 and the lower rectangular connection portions 130 extending downward. The connection portion 120 is then connected to the joists 106 in any manner. For example, nail or screw or other fasteners can be inserted through the connection portion 120 and into the joists 106. It is contemplated that an adhesive could alternately or additionally be employed. In the installed position, an upper edge 150 (see FIGS. 1 and 7) of the folded connection portion 120 is on a level with an upper edge 152 of the joists 106. The upper rectangular connection portion 126 of the connection portion 120 has a height to provide for proper spacing between the heated surface 134 and a bottom surface of the walking surface 104.

The illustrated heating assembly 102 includes a support panel 110 that allows for connection of the heating assembly 102 to a pair of joists 106 along with assisting in properly and easily positioning the heating assembly 102 in a location spaced from the walking surface 104. Therefore, the heating assembly 102 provides for heated flooring 100 to be formed in buildings during construction thereof and can be used to retrofit buildings to heat the flooring already installed in the buildings.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. Heated flooring comprising:
a plurality of spaced joists;
a support surface connected to tops of the joists; and
a heating assembly connected to the joists for heating a space between the support surface and the heating assembly;
the heating assembly including a support panel, a heated layer and a top layer, the heated layer being located between the support panel and the top layer, the heating assembly including a heated surface; and
the support surface having folded sides forming connection portions that are connected to the joists and accurately space the heated surface from a bottom of the support surface.

2. The heated flooring of claim 1, wherein:
the heated layer comprises graphene.

3. The heated flooring of claim 1, wherein:
the support panel includes a rectangular step wave pattern spaced from each longitudinal edge that defies a transition between a flat support portion and the connection portions, the connection portions are bent relative to the flat support portion, and the connection portions are connected to the joists.

4. The heated flooring of claim 3, wherein:
the rectangular step wave pattern includes an interrupted weakened line that forms a living hinge as the connection portion is bent relative to the flat support portion; and
the rectangular step wave pattern also includes a plurality of U-shaped cut lines that are cut through the support panel;
the connection portions are bent along the interrupted weakened line relative to the flat support portion.

5. The heated flooring of claim 4, wherein:
the connection portions each include an upper rectangular connection portion that extends upward from an upper surface of the flat support portion and a plurality of lower rectangular connection portions that extend downward from the flat support portion, with a plurality of rectangular openings being located between the flat support portion and the connection portions.

6. A heating assembly comprising:
a support panel;
a heated layer comprising graphene;
a top layer; and
a heated surface;
the heated layer being located between the support panel and the top layer to form the heated surface at a top of the heating assembly;
the support panel including a support portion and weakened fold lines along opposite longitudinal sides thereof forming connection portions;
wherein the connection portions are configured to be folded along the weakened fold lines and connected to joists of a building, thereby accurately spacing the heated surface from a bottom of a support surface.

7. The heating assembly of claim 6, wherein:
the support panel includes a rectangular step wave pattern spaced from each longitudinal edge that defies a transition between the support portion and the connection portions, the connection portions being configured to be bent relative to the support portion.

8. The heated flooring of claim 7, wherein:
the rectangular step wave pattern includes an interrupted weakened line forming the weakened fold lines that forms a living hinge as the connection portions are bent relative to the support portion; and
the rectangular step wave pattern also includes a plurality of U-shaped cut lines that are cut through the support panel;
the connection portion is bent along the interrupted weakened line relative to the flat support portion.

9. The heated flooring of claim 8, wherein:
the connection portions each include an upper rectangular connection portion that is configured to extend upward from an upper surface of the support portion and a plurality of lower rectangular connection portions that are configured to extend downward from the support portion, with a plurality of rectangular openings being located between the support portion and the connection portions when the connection portions are folded.
